(19) United States
(12) Patent Application Publication
(10) Pub. No.: US 2025/0003144 A1
(43) Pub. Date: Jan. 2, 2025

(54) A PROCESS FOR DECOLOURING TEXTILES

(71) Applicant: TEXTILE CHANGE APS, Vejle (DK)

(72) Inventors: Emma Thonesen Hostrup, Aarhus (DK); Ditte Hojland, Vejle (DK); Simon Hundahl Rossen, Galten (DK)

(21) Appl. No.: 18/705,648

(22) PCT Filed: Oct. 25, 2022
(86) PCT No.: PCT/EP2022/079790

§ 371 Date: Apr. 29, 2024

(30) Foreign Application Priority Data
Oct. 29, 2021 (DK) PA202101028

(51) Int. Cl. D06L 4/614; D06L 4/679; D06L 4/70

(52) U.S. Cl. CPC D06L 4/614; D06L 4/679; D06L 4/70

(57) ABSTRACT

A process is shown that relates to a process for providing at least one solid fraction from a textile product including a natural fibre and/or a synthetic fibre, wherein the process includes the steps of: i) proving the coloured textile product including a natural fibre and/or one or more synthetic fibres; ii) adding a liquid solution of dihydrolevoglucosenone and/or derivatives of dihydrolevoglucosenone in water, thereby providing a decolorized textile product; and iii) separating the decolorized textile product from the liquid fraction, thereby providing the at least one solid fraction.

### TECHNICAL FIELD OF THE INVENTION

The present invention relates to a process for decolouring textiles, and for preparing a textile product for recycling.

### BACKGROUND OF THE INVENTION

Around 85% of all textiles thrown away amounts in 2017 to roughly 13 million tonnes in US alone.

The textile waste is traditionally either dumped into landfill or burned.

Globally, it is estimated that 92 million tonnes of textile waste are created each year and is equivalent to one rubbish truck filled with clothes ending up on landfill sites every second. By 2030, it is expected that more than 134 million tonnes of textiles are discarded every year.

Disposal of such large volumes of textile waste is an increasing problem for the apparel industry. The rising costs, reduction in available space, and concern for the environment makes the burning and landfilling of textile waste dwindling options.

Reuse or recycling of the fibres from textiles has been investigated for decades and several methods exists. However, a large percentage of the textile waste comprises blends of fibres such as polyester/cellulosic fabrics, e.g., polyester/cotton and polyester/Tencel™ blends, but also other fibres may be included, such as elastane. The reuse or recycling of the individual blended materials is complicated by the fact that there are inherent differences in the physical properties and composition of the components. Additionally, the fabrics are treated with resinous materials and other finishing compounds, such as dyes. This makes it nearly impossible to find potential commercial end uses for this material other than rags or cloth scraps, which are of little monetary value.

Therefore, there is an interest in the industry for providing potential methods of recycling textile waste comprising blends of fibres, such as polyester/cotton fabric blends, which may be reused e.g., in textiles.

Another challenge of reusing textile waste comprising blends of fibres is the presence of dye in the textile. The decolorization of textile waste (pre- and postconsumer) is a huge issue in textile fibre-to-fibre recycling methods, due to a vast number of different dyes and the need to remove them before the textile waste materials can be dissolved and spun into recycled fibres.

When it comes to dyeing fibres, some fibres adhere to and accept dyes easily, while others do not. Depending on the purpose one is seeking to achieve by dyeing the fabric, and the type of dye one is planning to use, very different processes are needed. The dyes are classified by different classification systems, such as chemical classes (e.g., indigoid dyes and azo dyes, such as mono-, di-, and tri-azo dyes) and dye classes (e.g., disperse dyes, vat dyes, insoluble azo dyes, and reactive dyes).

Reactive dyes are extensively used in the dying of cellulosic fabrics, such as cotton. The reactive dye makes a covalent bond with the polymer fibre, thereby becoming an integral part thereof. The term “reactive” is due to this type of dye being the only type of dye that has a reactive group, which reacts chemically with the polymer fibre molecules to form covalent bonds. The use of reactive dyes is increasing. However, one of the challenges with reactive dyes is the subsequent stripping from the fibres during recycling. Traditionally, it is believed that reactive dye cannot be satisfactorily stripped from the fibre due to the covalent bond between dye molecule and fibre. Since stripping of the dyes including the reactive dyes becomes necessary when textiles are to be reused—a satisfactorily stripping of reactive dyes from the textile fibres is therefore desirable.

Hence, it is desirable to provide a process for recovering the individual solid fractions from a textile product. In particular, a process for recovering solid fractions, which are decoloured, which process is easy, reliable, efficient, environmentally friendly, cheap, and fast would be advantageous.

### SUMMARY OF THE INVENTION

Thus, an object of the present invention relates to a process for recycling at least one solid fraction from a coloured textile product.

In particular, it is an object of the present invention to provide a process that solves the above-mentioned problems of the prior art with recovering decoloured solid fractions in an easy, reliable, efficient, environmentally friendly, cheap, and fast manner.

Thus, one aspect of the invention relates to a process for providing at least one solid fraction from a coloured textile product comprising a natural fibre and/or a synthetic fibre, the process comprising the steps of:
(i) proving the coloured textile product comprising a natural fibre and/or one or more synthetic fibres;
(ii) adding a liquid solution of dihydrolevoglucosenone and/or derivatives of dihydrolevoglucosenone in water, thereby providing a decolorized textile product; and
(iii) separating the decolorized textile product from the liquid fraction, thereby providing the at least one solid fraction.

In the present context, the term “solid fraction” is meant to include both a powder fraction and/or a fibrous fraction.

In the present context, the term “synthetic fibre” is meant also to include semi-synthetic fibres.

Yet another aspect of the present invention relates to the use of the solid fractions, in particular the natural fibre, according to the present invention in the preparation of a textile product.

A further aspect of the present invention relates to a textile product comprising the solid fractions, in particular the natural fibre, according to the present invention.

Still another aspect relates to a solid fraction produced by the process according to the present invention.

The present invention will now be described in more detail in the following.

### DETAILED DESCRIPTION OF THE INVENTION

Accordingly, the inventors of the present invention surprisingly found an efficient process of removal of reactive dyes from the textile product allowing for a better usage of the solid fraction(s).

This invention makes it possible to decolorize untreated or pre-treated (alkali and/or acid pre-treatments) textile fabrics. Pure dihydrolevoglucosenone (Cyrene™) was initially tried as a solvent for separating polyester and cotton from a textile blend. Little effect on decolorization was observed. However, surprisingly, when water was added to the dihydrolevoglucosenone, a positive side effect was observed as the textile fibres were markedly decolorized. The inventors discovered that the addition of water to dihydrolevoglucosenone increases the ability to decolorize the textile fibres, both with and without the pre-treatments. An optimum occurs between 10-50 wt % water in dihydrolevoglucosenone when heated at 95-101 degrees Celsius. The decolorization performs better when water reaches its boiling point.

The potential of this invention is huge, since dihydrolevoglucosenone is a very low toxicy solvent made from waste cellulosic biomass and its carbon footprint is up to 80% lower than DMSO, NMP, or DMF. The invention has the potential to help further textile recycling by providing an effective decolorization process, while lowering safety risks and climate impact.

Hence, a preferred embodiment of the present invention relates to a process for providing at least one solid fraction from a coloured textile product comprising a natural fibre and/or a synthetic fibre, the process comprising the steps of:
(i) proving the coloured textile product comprising a natural fibre and/or one or more synthetic fibres;
(ii) adding a liquid solution of dihydrolevoglucosenone and/or derivatives of dihydrolevoglucosenone in water, thereby providing a decolorized textile product; and
(iii) separating the decolorized textile product from the liquid fraction, thereby providing the at least one solid fraction.

Derivatives of dihydrolevoglucosenone may e.g., be ketal derivatives, i.e., where the ketone (>C═O) of dihydrolevoglucosenone is converted to a ketal (>C(OR1)(OR2)), and where R1 and/or R2 represents a lower alkyl, such as methyl, ethyl, or propyl, and where R1 and R2 may be covalently bonded to one another to form a cyclic ketal, such as cygnet types, where the ketone of dihydrolevoglucosenone is converted to a the cyclic ketal >C(OCHR1)(OCHR2), and where R1 and/or R2 represents a hydrogen or a lower alkyl, such as methyl, ethyl, or propyl. Other derivatives may be levoglucosenone, the geminal diol of levoglucosenone, and the geminal diol of dihydrolevoglucosenone. The latter is automatically formed to some extent when dihydrolevoglucosenone is mixed with water. Again, the ketone (>C═O) of levoglucosenone is converted to a ketal (>C(OR1)(OR2)), and where R1 and/or R2 represents a lower alkyl, such as methyl, ethyl, or propyl, and where R1 and R2 may be covalently bonded to one another to form a cyclic ketal, e.g., where the ketone of dihydrolevoglucosenone is converted to a the cyclic ketal >C(OCHR1)(OCHR2), and where R1 and/or R2 represents a hydrogen or a lower alkyl, such as methyl, ethyl, or propyl. The production of such compounds is well-known to the skilled person within the art of organic chemistry, such as the use of suitable alcohols for the formation of ketals from ketones.

In one or more embodiments, the liquid solution of dihydrolevoglucosenone and/or derivatives of dihydrolevoglucosenone in water comprises from about 5% w/w to about 90% w/w water and from about 95% w/w to about 10% w/w dihydrolevoglucosenone and/or derivatives of dihydrolevoglucosenone, such as from about 10% w/w to about 85% w/w water and from about 90% w/w to about 15% w/w dihydrolevoglucosenone and/or derivatives of dihydrolevoglucosenone, e.g., from about 15% w/w to about 80% w/w water and from about 85% w/w to about 20% w/w dihydrolevoglucosenone and/or derivatives of dihydrolevoglucosenone, such as from about 20% w/w to about 75% w/w water and from about 80% w/w to about 25% w/w dihydrolevoglucosenone and/or derivatives of dihydrolevoglucosenone, e.g., from about 25% w/w to about 70% w/w water and from about 75% w/w to about 30% w/w dihydrolevoglucosenone and/or derivatives of dihydrolevoglucosenone, such as from about 30% w/w to about 65% w/w water and from about 70% w/w to about 35% w/w dihydrolevoglucosenone and/or derivatives of dihydrolevoglucosenone, e.g., from about 35% w/w to about 60% w/w water and from about 65% w/w to about 40% w/w dihydrolevoglucosenone and/or derivatives of dihydrolevoglucosenone, such as from about 40% w/w to about 55% w/w water and from about 60% w/w to about 45% w/w dihydrolevoglucosenone and/or derivatives of dihydrolevoglucosenone, preferably, from about 10% w/w to about 50% w/w water and from about 90% w/w to about 50% w/w dihydrolevoglucosenone and/or derivatives of dihydrolevoglucosenone.

In one or more embodiments, the liquid solution of dihydrolevoglucosenone and/or derivatives of dihydrolevoglucosenone in water consists essentially of from about 5% w/w to about 90% w/w water and from about 95% w/w to about 10% w/w dihydrolevoglucosenone and/or derivatives of dihydrolevoglucosenone, such as from about 10% w/w to about 85% w/w water and from about 90% w/w to about 15% w/w dihydrolevoglucosenone and/or derivatives of dihydrolevoglucosenone, e.g., from about 15% w/w to about 80% w/w water and from about 85% w/w to about 20% w/w dihydrolevoglucosenone and/or derivatives of dihydrolevoglucosenone, such as from about 20% w/w to about 75% w/w water and from about 80% w/w to about 25% w/w dihydrolevoglucosenone and/or derivatives of dihydrolevoglucosenone, e.g., from about 25% w/w to about 70% w/w water and from about 75% w/w to about 30% w/w dihydrolevoglucosenone and/or derivatives of dihydrolevoglucosenone, such as from about 30% w/w to about 65% w/w water and from about 70% w/w to about 35% w/w dihydrolevoglucosenone and/or derivatives of dihydrolevoglucosenone, e.g., from about 35% w/w to about 60% w/w water and from about 65% w/w to about 40% w/w dihydrolevoglucosenone and/or derivatives of dihydrolevoglucosenone, such as from about 40% w/w to about 55% w/w water and from about 60% w/w to about 45% w/w dihydrolevoglucosenone and/or derivatives of dihydrolevoglucosenone, preferably, from about 10% w/w to about 50% w/w water and from about 90% w/w to about 50% w/w dihydrolevoglucosenone and/or derivatives of dihydrolevoglucosenone.

In one or more embodiments, step (ii) is performed at a temperature within the range of 95-110 degrees Celsius, such as within the range of 97-108 degrees Celsius, e.g., within the range of 99-106 degrees Celsius, preferably within the range of 98-102 degrees Celsius.

Fibres are natural or synthetic substances that are significantly longer than they are wide. Fibres are used in the manufacture of other materials like textiles.

Natural fibres may e.g., be produced by plants or algae and may include cellulose and may be provided e.g., as cotton, hemp, sisal, bamboo, viscose, lyocell, or TENCEL™.

Synthetic fibres are synthesized in large amounts compared to the separation of natural fibres, but for clothing natural fibres provides benefits, like comfort and water sorption, over their synthetic counterparts.

Before treating the textile product, the textile product may be shredded to smaller pieces. Preferably the smaller pieces of textile product may be below approximately 10×10 cm, such as below 5×5 cm, e.g., below 1×1 cm.

As mentioned herein, the removal of dyes is of outmost importance for providing a high value solid fraction. At present, it is not known how the liquid solution of dihydrolevoglucosenone and/or derivatives of dihydrolevoglucosenone in water removes the dye(s) from the solid fraction, but it may be speculated that the solution dissolves and/or chemically cleaves, e.g., by hydrolysis or the like, the dye from the textile fibres. and may thereby be separated from the solid fraction as a colour-fraction, e.g., by draining, centrifugation, or filtration.

The colour-fraction according to the present invention may comprise solubilised pigments. Preferably, the solubilized pigments include reactive dyes, insoluble azo dyes, vat dyes, and/or dispersed dyes, but other dyes may also be present.

Reactive dyes may be a class of dyes, which makes covalent bonds with the fibres and becomes a part of the fibres. Reactive dyes are traditionally difficult to remove from textile products. The reactive dye contains a functional group that reacts with the polymers in the textile fibres. Reactive dyes have good fastness properties owing to the covalent bonding that occurs during dyeing. Reactive dyeing is the most important method for the coloration of cellulosic fibres.

Vat dyes is used to describe a chemical class of dyes that are applied to cellulosic fibre (e.g., cotton) using a redox reaction in the process. The most common reducing agent is sodium dithionite (Na₂S₂O₄), which converts the dye to its “leuco” form that is water soluble. Once attached to the fabric fibres, the leuco dye is then oxidized to the insoluble state, which is intensely coloured. One example of such a dye is indigo dye.

Disperse dyes are in general small, planar and non-ionic molecules, with attached polar functional groups like hydroxyalkyl, —NO₂ and —CN. Its shape and size make it possible for the dye to slide between the tightly packed polymer chains in the textile fibres, and the polar groups improve water solubility and dipolar bonding between dye and polymer, as well as affecting the hue of the dye. The interactions between dye and polymer are thought to be van der Waals and dipole forces. Disperse dyes are formulated to permit dyeing of hydrophobic thermoplastic fibres including nylon, polyester, acrylic, and other synthetic fibres.

Insoluble azo dyes (water-insoluble azo dyes) are used for dyeing polyester- and cotton-based textiles. An insoluble azo dye is produced directly onto or within a fibre. Diazonium ions are produced when for example an aryl amine is reacted in aqueous solution with a dissolved nitrite of an alkali metal in the presence of hydrochloric acid or alternatively, with an organic nitrite, e.g., t-butylnitrite in an organic solvent. A diazonium ion is a reactive intermediate that is capable of undergoing substitution or coupling reactions. For example, groups like halogen, cyamide, hydroxyl, or hydrogen may substitute for a diazo group bonded to an arene (ArN2+). Compounds such as aniline and phenol, in which strong electron donating groups (e.g., —OH and —NH2) activate the ortho and para positions on a benzene ring, can undergo coupling reactions with a diazonium ion. The mechanism of a coupling reaction is an electrophilic aromatic substitution reaction.

In an embodiment of the present invention the presence of dyes in the at least one solid fraction is invisible to the human eye.

In a further embodiment of the present invention the content of dyes in the at least one solid fraction is reduced by at least 25%, such as by at least 50%; e.g., by at least 75%, such as by at least 85%; e.g., by at least 90%, such as by at least 95%; e.g., by at least 98% relative to the coloured textile product.

In order to further improve the removal of the dyes, in particular reactive dyes, the textile product comprising a natural fibre and/or one or more synthetic fibres may be subjected to a pre-treatment before adding the liquid solution of dihydrolevoglucosenone and/or derivatives of dihydrolevoglucosenone in water to the textile product in step (ii).

In an embodiment of the present invention the pre-treatment comprises one, two or three steps selected from:
(a) an acidic treatment;
(b) an alkaline treatment;
(c) a hydrogen peroxide;
(d) or a combination of (a), (b) and (c).

In one or more embodiments, the pre-treatment comprises the combination of (b) an alkaline treatment and (c) a hydrogen peroxide treatment.

In yet an embodiment of the present invention the pre-treatment comprises:
an acidic pre-treatment; or
an acidic pre-treatment and an alkaline pre-treatment; or
an acidic pre-treatment and an alkaline pre-treatment and a hydrogen peroxide pre-treatment; or
an alkaline pre-treatment; or
an alkaline pre-treatment and a hydrogen peroxide pre-treatment; or
a hydrogen peroxide pre-treatment.

Preferably, the pre-treatment may involve at least the acidic pre-treatment (pre-treatment (a)); or the acidic pre-treatment (pre-treatment (a)) in combination with the alkaline pre-treatment (pre-treatment (b)); the acidic pre-treatment (pre-treatment (a)) in combination with the hydrogen peroxide pre-treatment (pre-treatment (c)).

When the pre-treatment involves a combination of the acidic pre-treatment (pre-treatment (a)); the alkaline pre-treatment (pre-treatment (b)); and/or the hydrogen peroxide pre-treatment (pre-treatment (c)), the pre-treatment may be performed simultaneously or sequentially. Preferably, the pre-treatments are performed sequentially.

The sequence of acidic pre-treatment (pre-treatment (a)); the alkaline pre-treatment (pre-treatment (b)); and/or the hydrogen peroxide pre-treatment (pre-treatment (c)) may be optional.

The acidic pre-treatment (pre-treatment (a)) may be performed using a strong acid. The strong acid may be selected from the group consisting of HCl (hydrochloric acid); H₂SO₄ (sulfuric acid); HNO₃ (nitric acid); HBr (hydrobromic acid); HClO₄ (perchloric acid); or HI (hydroiodic acid). Preferably, the strong acid is H₂SO₄ (sulfuric acid).

In an embodiment of the present invention the concentration of the acid used in the acidic pre-treatment may have a concentration in the range of 0.1-3M (moles per litre), such as in the range of 0.3-2.5M, e.g., in the range of 0.5-2.0M, such as in the range of 0.6-1.5M, e.g., in the range of 0.75-1.0M.

The acidic pre-treatment may preferably be performed at a temperature in the range of 20-95° C. (degrees Celsius), such as in the range of 30-85° C., e.g., in the range of 40-75° C., such as in the range of 50-65° C., e.g., about 60° C.

The acidic pre-treatment may preferably be performed for a period in the range of 5-60 minutes, such as for a period of 15-45 minutes, e.g., for about 30 minutes. Obviously, the pre-treatment may be performed for even longer time, but without any significantly improved effect.

The alkaline pre-treatment (pre-treatment (b)) may be performed using a strong base. Strong bases may be bases which completely dissociate in water into the cation and OH— (hydroxide ion). In an embodiment of the present invention hydroxides of the Group I (alkali metals) and Group II (alkaline earth) metals are considered strong bases.

In a further embodiment of the present invention the strong base may be selected from a hydroxide compound. Preferably, the strong base may be selected from the group consisting of NaOH (sodium hydroxide); LiOH (lithium hydroxide); KOH (potassium hydroxide); RbOH (rubidium hydroxide); CsOH (cesium hydroxide); Ca(OH)₂ (calcium hydroxide); Sr(OH)₂ (strontium hydroxide); and/or Ba(OH)₂ (barium hydroxide).

In one embodiment of the present invention, the concentration of the base used in the alkaline pre-treatment may have a concentration in the range of 5-25 wt %, such as in the range of 8-20 wt % (weight percent), e.g., in the range of 9-15 wt %, such as about 10 wt %.

The alkaline pre-treatment may preferably be performed at a temperature in the range of 20-95° C., such as in the range of 30-90° C., e.g., in the range of 40-85° C., such as in the range of 60-75° C., e.g., about 70° C.

The alkaline pre-treatment may preferably be performed for a period in the range of 5-60 minutes, such as for a period of 15-45 minutes, e.g., for about 30 minutes.

The hydrogen peroxide pre-treatment (pre-treatment (c)) may be performed using a concentration of hydrogen peroxide in the range of 5-25 wt %, such as in the range of 8-20 wt %; e.g., in the range of 9-15 wt %, such as about 10 wt %.

The hydrogen peroxide pre-treatment (pre-treatment (c)) may include a base, preferably a strong base, e.g., a strong base as mentioned herein. Preferably, the hydrogen peroxide solution may have a concentration of strong base in the range of 5-25 wt %, such as in the range of 8-20 wt %, e.g., in the range of 9-15 wt %, such as about 10 wt %.

The hydrogen peroxide pre-treatment (pre-treatment (c)) may include a step of adjusting the pH-value of the hydrogen peroxide solution. Preferably, the pH-value of the hydrogen peroxide solution may be adjusted to a pH-value in the range of pH 9-14, such as in the range of pH 10-13; e.g., pH 12.

The hydrogen peroxide pre-treatment may preferably be performed at a temperature in the range of 20-95° Celsius (C), such as in the range of 30-90° C., e.g., in the range of 40-85° C., such as in the range of 60-75° C., e.g., about 70° C.

The hydrogen peroxide pre-treatment may preferably be performed for a period in the range of 5-60 minutes, such as for a period of 15-45 minutes, e.g., for about 30 minutes.

Obviously, the pre-treatment may be performed for even longer time, but without any significantly improved effect.

The acidic pre-treatment (pre-treatment (a)); the alkaline pre-treatment (pre-treatment (b)); and/or the hydrogen peroxide pre-treatment (pre-treatment (c)) may be supplemented with a chelating agent.

Preferably, the alkaline pre-treatment (pre-treatment (b)); and/or the hydrogen peroxide pre-treatment (pre-treatment (c)) may be supplemented with a chelating agent. Sodium carbonate has proven particularly efficient at dissolving silicate particles.

The chelating agent may during the pre-treatment, and/or during the decolourization in steps (ii) or (iii), scavenges metallic ions from the pigments used and ensuring solubility of the pigments and removing silicates (e.g., SiO₂) and metal-ions from the textile product.

In an embodiment of the present invention the concentration of the chelating agent supplemented may have a concentration in the range of 1-100 mg/l, such as in the range of 5-75 mg/l, e.g., in the range of 10-60 mg/l, such as in the range of 15-50 mg/l, e.g., in the range of 25-40 mg/l, such as about 35 mg/l.

The pre-treatment of the textile product assist in removing dyes from the textile products. The inventors of the present invention found that the dye of the textile product is not removed during the pre-treatment step, but the pre-treatment results in an improved release and removal of dye during the following addition of the liquid solution of dihydrolevoglucosenone and/or derivatives of dihydrolevoglucosenone in water to the textile product in step (ii).

Furthermore, the inventors of the present invention surprisingly found that not only water-soluble dyes, but also water-insoluble dyes may be effectively removed from the textile product. In particular, the process according to the present invention showed to be extremely effective in removing disperse dyes, insoluble azo dyes, vat dyes, and reactive dyes from the textile product.

The content of reactive dyes in the textile product may be indicated by whiteness measurements, e.g., performed according to DIN53 145.

In one embodiment of the present invention, the textile product comprising a natural fibre and/or one or more synthetic fibres, which has been subjected to a pre-treatment before performing step (ii), may after the pre-treatment be subjected to a washing step.

The washing step may be provided to avoid the compounds used during the pre-treatment(s) of the textile product interferes with the decolouration step (step ii)), e.g., reacts with dihydrolevoglucosenone and/or derivatives of dihydrolevoglucosenone.

In one embodiment of the present invention, the washed textile product may be subjected to a drying step before performing step (ii).

The effect of the drying step may be to avoid diluting the liquid solution of dihydrolevoglucosenone and/or derivatives of dihydrolevoglucosenone in water, and/or ensuring controlling the concentration of the solution, when added to the textile product after the textile product has been subjected to the pre-treatment.

The colour-fraction comprises dyes, and may comprise SiO₂, and metals-ions present in the textile product. Furthermore, the colour-fraction may comprise soluble polymers from the textile product, such as polyether and/or a polyurethane. The polyurethane may be elastane.

After cooling of the colour-fraction, e.g., to room temperature, the polyether and/or the polyurethane may be separated from the colour fraction, e.g., by skimming or decanting, to form a second solid fraction. The second solid fraction may preferably consist essentially of a polyether and/or a polyurethane compound, except for minor impurities.

In one or more embodiments, a solvent may be added to the decolorized textile product to solubilize the decolorized textile product or parts hereof, thereby providing a solubilised fraction and an un-solubilised fraction. The solubilised fraction preferably comprises a second solid fraction. The un-solubilised fraction comprises a third solid fraction.

In a further embodiment of the present invention the solubilised fraction preferably consists essentially of a second solid fraction, except for a minor impurity of the first solid fraction and/or the third solid fraction.

In yet an embodiment of the present invention the un-solubilised fraction consists essentially of a third solid fraction, except for a minor impurity of the first solid fraction and/or the second solid fraction.

In the context of the present invention the term “a minor impurity” relates to a content of the solid fraction in question of at most 5 wt %, such as at most 4 wt %, e.g., at most 3 wt %, such as at most 2 wt %, e.g., at most 1 wt %, such as at most 0.75 wt %, e.g., at most 0.5 wt %, such as at most 0.1 wt %, e.g., at most 0.05 wt %.

In an embodiment of the present invention the second solid fraction comprises (or consist essentially of) a polyester compound and/or the third solid fraction comprises (or consist essentially of) a cellulose compound.

The polyester compound may be Polyethylene terephthalate (PET).

The decolorization performed in step (ii) may preferably be controlled (e.g., by adjusting time, temperature, and/or chemical(s)) to avoid or limit solubility of polyester (when present in the textile product).

In an embodiment of the present invention the solubilization (of the solubilised fraction) may be performed at a temperature in the range of 170-200° C., such as in the range of 180-190° C., e.g., about 185° C.

When solubilised, the solubilised fraction may be separated from the un-solubilised fraction.

The resulting solubilised fraction may be subjected to a crystallisation process, providing a crystallized synthetic solid fraction.

In an embodiment of the present invention the synthetic solid fraction may, after being separated from the un-solubilised fraction, be crystallized be collected in a tank and cooled, e.g., to about room temperature, whereby the synthetic solid fraction may crystalise. Following the crystallisation, the crystalised synthetic solid fraction may be separated by filtration or centrifugation. The resulting isolated crystalised synthetic solid fraction may optionally be dried, before being melted into a single piece of synthetic solid fraction.

The crystallized synthetic solid fraction may be collected as a particulate fraction and optionally dried to a powder fraction. Preferably, the crystallization process includes the presence of the solvent and a temperature below 170° C., such as below 160° C., e.g., below 140° C., such as below 120° C., e.g., below 100° C., such as below 75° C., e.g., below 50° C., such as below 35° C., e.g., below 25° C.

In one or more embodiments, wherein when the textile product comprises a mixture of synthetic fibres and natural fibres, and wherein the process further comprises the steps of:
(iv) adding a solvent to the decolorized textile product (the separated solid fraction),
(v) allowing the solvent to react with the decolorized textile product at a temperature between 170-200° C., thereby providing a solubilised fraction and an un-solubilised fraction;
(vi) separating the solubilised fraction (liquid fraction) from the un-solubilised fraction (solid fraction), thereby providing a solubilised fraction comprising the synthetic fibre, and an un-solubilised fraction comprising the natural fibre.

In one or more embodiments, the textile product comprises polyester fibres and cellulose fibres.

In an embodiment of the present invention the synthetic fibre provided in step (vi) comprises (or consist essentially of) a polyester fibre.

In yet an embodiment of the present invention the natural fibre provided in step (vi) comprises (or consist essentially of) a cellulose fibre.

In an embodiment of the present invention the un-solubilised fraction may be subjected to a washing process, preferably an aqueous washing process, preferably using pure water.

Following the washing process, the un-solubilised fraction may be dried and spun to a fibre product.

In one or more embodiments, the solvent is selected from an aprotic solvent, such as dihydrodihydrolevoglucosenone (Cyrene), dimethyl sulfoxide (DMSO), methyl-sulfonyl-methane (DMSO₂), sulfolane, or a combination thereof. Preferably, the aprotic solvent has a boiling point above 180 degrees Celsius, such as within the range of 185-300 degrees Celsius.

In a further embodiment of the present invention, the aprotic solvent comprises (consist essentially of) an organosulfur compound.

The organosulfur compound may preferably be selected from dimethyl sulfoxide (DMSO), methyl-sulfonyl-methane (DMSO2), sulfolane, or a combination thereof.

Preferably the solvent used may be isolated and recircled. The isolation may be possible e.g., by evaporation, distillation, Membrane Cross flow filtration, OSN (organic solvent Nanofiltration), antisolvent precipitation, crystallization, or the like. Such techniques are generally known within the art.

In one or more embodiments, the process steps are performed in the same reactor.

The inventors of the present invention have surprisingly found that the process according to the present invention results in a high quality of the solid fraction comprising natural fibres with little degradation and at the same time with little dye left in the fibre.

Thus, a preferred embodiment of the present invention relates to a solid fraction obtained from a textile product comprising a natural fibre having a degree of polymerization (DP) above 500, e.g., above 1000, such as above 1500, e.g., above 2000, such as above 2500, e.g., above 3000, such as above 3500, e.g., above 4000, such as above 4500 and/or having a whiteness of at least 50% measured by DIN53 145, preferably at least 60%, e.g., at least 70%, such as at least 80%, and more preferably at least 90%, such as at least 95%, e.g., at least 99%.

In an embodiment of the present invention 25 wt % or more of the natural fibre comprises a degree of polymerization (DP) above 500, e.g., above 1000, such as above 1500, e.g., above 2000, such as above 2500, e.g., above 3000, such as above 3500, e.g., above 4000, such as above 4500, such as 30 wt % or more, e.g., 40 wt % or more, such as 50 wt % or more, e.g., 60 wt % or more, such as 70 wt % or more, e.g., 80 wt % or more, such as 90 wt % or more, e.g., 95 wt % or more, such as 98 wt % or more.

In yet an embodiment of the present invention less than 25 wt % of the natural fibre comprises a degree of polymerization (DP) less than 500, such as less than 20 wt %, e.g., less than 15 wt %, such as less than 10 wt %, e.g., less than 5 wt %, such as less than 2 wt %, e.g., less than 1 wt %.

Preferably, the content of one or more synthetic fibres (or fractions hereof) in the solid fraction, the natural solid fraction, is less than 15 wt %, such as less than 10 wt %, e.g., less than 5 wt %, such as less than 2 wt %, e.g., less than 1 wt %, such as less than 0.5 wt %, e.g., less than 0.1 wt %, such as less than 0.05 wt %.

In yet an embodiment of the present invention:
25 wt % or more of the natural fibre comprises a degree of polymerization (DP) above 300, such as above 500, e.g., above 1000, such as above 1500, e.g., above 2000, such as above 2500, e.g., above 3000, such as above 3500, e.g., above 4000, such as above 4500, such as 30 wt % or more, e.g., 40 wt % or more, such as 50 wt % or more, e.g., 60 wt % or more, such as 70 wt % or more, e.g., 80 wt % or more, such as 90 wt % or more, e.g., 95 wt % or more, such as 98 wt % or more; and/or
less than 25 wt % of the natural fibre comprises a degree of polymerization (DP) less than 300, such as less than 20 wt %, e.g., less than 15 wt %, such as less than 10 wt %, e.g., less than 5 wt %, such as less than 2 wt %, e.g., less than 1 wt %; and/or
the content of one or more synthetic fibres (or fractions hereof) in the solid fraction is less than 15 wt %, such as less than 10 wt %, e.g., less than 5 wt %, such as less than 2 wt %, e.g., less than 1 wt %, such as less than 0.5 wt %, e.g., less than 0.1 wt %, such as less than 0.05 wt %.

Preferably, the dye content of the solid fraction is invisible to the human eye.

It should be noted that embodiments and features described in the context of one of the aspects of the present invention also apply to the other aspects of the invention.

### Examples

In one example of the invention, eight square pieces of textile was cut from an item of work wear, discarded from an industrial laundry. The content of the fabric was 41% cellulose fibres (Tencel®), 34% cotton, 23% polyester, 2% elastane, and the fibres were coloured with a bright blue colour dye, possibly a vat dye, such as an indigoid dye, due to the large weight percentage of cotton, but possibly alternatively, or in combination, a reactive dye due to the content of cellulose fibres, although indigoid dyes are also suitable for such fibres. The eight squares of fabric all weighed 1±0.1 g and were charged, respectively, into eight different solvent mixtures of varying dihydrolevoglucosenone to water ratios, with the amount of water constituting 0 wt %, 10 wt %, 20 wt %, 30 wt %, 40 wt %, 50 wt %, 70 wt % and 100 wt %, respectively. Each sample contained 200 g of solvent and was heated to 96-98° C. using a CASO TC 2100 THERMO CONTROL INDUCTION HUB for temperature control for 30 minutes. The water content was kept constant by a condensation apparatus. Afterwards, the samples were rinsed in demineralized water and dried overnight. The result of the decolorizing procedure was measured using a PCE-WSB 1 portable handheld battery-powered brightness/whiteness colorimeter, purchased from pce-instruments.com. The colorimeter measures the intensity of light reflection (whiteness degree of blue light (Wb=R457)) diffused on a scale of 100, calibrated against an absolute black surface for level 1. The light reflection value is used to determine the brightness level, meeting ISO 2470 (Paper, board and pulps—Measurement of diffuse blue reflectance factor—Part 1: Indoor daylight conditions (ISO brightness) and ISO 3688 (Pulps—Preparation of laboratory sheets for the measurement of diffuse blue reflectance factor (ISO brightness)) standards. The result was a visible change of brightness, with the highest change shown in the 20 wt % water content sample, compared to the negative control sample, which was the untreated fabric. The results are shown in the table below.

| | Water content in wt % | | | | | | | | |
|---|---|---|---|---|---|---|---|---|---|
| | | | | | | | | | Negative |
| | 0 | 10 | 20 | 30 | 50 | 70 | 90 | 100 | control sample |
| Brightness on a | 21.1 | 44.9 | 56.5 | 31.1 | 39.0 | 24.1 | 17.8 | 17.8 | 17.0 |
| scale from 1-100 | | | | | | | | | |
| Resolution: 0.1 | | | | | | | | | |
| Repeat accuracy: +0.1 | | | | | | | | | |

2) In another example of the invention, pure polyester fabric was mechanically shredded into separate yarn pieces of 3-10 cm lengths. The material was a mix of fabrics from postconsumer textiles, and therefore contained fibres of at least ten different colours (hence, a mixture of several dyes, possibly a mixture of disperse dyes, and water-insoluble azo dyes). The sample was pre-treated in a 10% NaOH solution and the treatment was done in a 1 L bluecap flask in an oil bath, using a CASO TC 2100 THERMO CONTROL INDUCTION HUB for temperature control. The sample was heated to 70° C. in the oil bath and stirred for 30 minutes. The stirring was done manually every few minutes. The sample was drained in a kitchen sieve and rinsed in demineralized water, before transferring it to another bluecap flask with a solution of 1M H2SO4 from Supelco®, purchased from Sigma Aldrich. It was treated at 60 degrees Celsius for 30 minutes at a concentration of 5 wt % textile. Then, the sample was washed in demineralized water, drained and dried overnight. The sample was then transferred to a solution of 30 wt % water in Dihydrolevoglucosenone, provided from Circa Group Ltd, with 5 wt % textile content, and rapidly heated in oil bath to a temperature of 99° C. The sample was treated for 30 minutes, and the solvent was changed two times, although visible decolorization happened after only one, and especially two rounds of treatment in solvent. After rinsing in demineralized water and drying the sample, whiteness measurements was performed with a PCE-WSB 1 device, purchased from PCE-instruments.com, which complies with ISO 2471-77 (Paper and board—Determination of opacity (paper backing)—Diffuse reflectance method). The result was a brightness of 50.2+0.1, which is an obvious colour reduction, compared to the initial brightness of the sample, which was 15.4+0.1 before any treatment, and 26.1+0.1 after alkali-acid pre-treatment.
3) In another example 50 grams of polycotton blended fabric of at least 30 different pieces clothing items was shredded into pieces of 3-20 mm and pretreated in 10 wt % NaOH solution for 30 minutes at 70° C. at 5 wt % textile to solution. Then the sample was treated in 1 M H2SO4 at 60° C. for 30 minutes, also with 5 wt % textile to solution. The sample was washed with demineralized water, drained and dried before transferred into 30 wt % water in Dihydrolevoglucosenone again with 5 wt % textile to solution. The sample was treated at 99° C. for 30 minutes with two solvent exchanges and then rinsed in demineralized water and dried. The brightness was taken as a mean of 10 measurements in both the initial and final sample due to great colour variation in the many different textiles. The colour was known to be primarily reactive dyes and therefore a small amount of decolourization was expected. Surprisingly, the increase in brightness was measured to be 416% with a mean of 8.9 level brightness in the initial sample with a standard deviation of 2.9 and a mean of 37.1 level brightness in the final sample with a standard deviation of 3.9.

1. A process for providing at least one solid fraction from a coloured textile product comprising a natural fibre and/or a synthetic fibre, the process comprising the steps of:
(i) proving the coloured textile product comprising a natural fibre and/or one or more synthetic fibres;
(ii) adding a liquid solution of dihydrolevoglucosenone and/or derivatives of dihydrolevoglucosenone in water, thereby providing a decolorized textile product;
(iii) separating the decolorized textile product from the liquid fraction, thereby providing the at least one solid fraction.

2. The process according to claim 1, wherein the liquid solution of dihydrolevoglucosenone and/or derivatives of dihydrolevoglucosenone in water comprises from about 5% w/w to about 90% w/w water and from about 95% w/w to about 10% w/w dihydrolevoglucosenone and/or derivatives of dihydrolevoglucosenone.

3. The process according to claim 1, wherein the liquid solution of dihydrolevoglucosenone and/or derivatives of dihydrolevoglucosenone in water consists essentially of from about 5% w/w to about 90% w/w water and from about 95% w/w to about 10% w/w dihydrolevoglucosenone and/or derivatives of dihydrolevoglucosenone.

4. The process according to claim 1, wherein the liquid solution of dihydrolevoglucosenone and/or derivatives of dihydrolevoglucosenone in water comprises from about 10% w/w to about 50% w/w water and from about 90% w/w to about 50% w/w dihydrolevoglucosenone and/or derivatives of dihydrolevoglucosenone.

5. The process according to claim 1, wherein the liquid solution of dihydrolevoglucosenone and/or derivatives of dihydrolevoglucosenone in water consists essentially of from about 10% w/w to about 50% w/w water and from about 90% w/w to about 50% w/w dihydrolevoglucosenone and/or derivatives of dihydrolevoglucosenone.

6. The process according to claim 1, wherein said coloured textile product is subjected to a pre-treatment before addition of said liquid solution in step (ii), preferably followed by a drying step, before step (ii); and wherein said pre-treatment comprises one, two, or three steps selected from:
(a) an acidic treatment;
(b) an alkaline treatment;
(c) a hydrogen peroxide treatment;
(d) or a combination of (a), (b) and/or (c).

7. The process according to claim 6, wherein said pre-treatment comprises the combination of steps (b) and (c).

8. The process according to claim 1, wherein step (ii) is performed at a temperature within the range of 95-110 degrees Celsius, preferably within the range of 98-102 degrees Celsius.

9. The process according to claim 1, wherein the coloured textile product comprises fibres selected from cotton, polyester, cellulose fibres, and mixtures thereof.

10. The process according to claim 1, wherein when the textile product comprises a mixture of synthetic fibres and natural fibres, and wherein the process further comprises the steps of:
(iv) adding a solvent to the decolorized textile product (the separated solid fraction),
(v) allowing the solvent to react with the decolorized textile product at a temperature between 170-200° C., thereby providing a solubilised fraction and an un-solubilised fraction; and
(vi) separating the solubilised fraction (liquid fraction) from the un-solubilised fraction (solid fraction), thereby providing a solubilised fraction comprising the synthetic fibre, and an un-solubilised fraction comprising the natural fibre.

11. A solid fraction produced by the process according to claim 1.
